(19) United States
(12) Patent Application Publication
(10) Pub. No.: US 2014/0059466 A1
(43) Pub. Date: Feb. 27, 2014

(54) MOBILE DEVICE WITH GRAPHICAL USER INTERFACE FOR MONITORING A BUILDING AUTOMATION SYSTEM

(71) Applicant: TRANE INTERNATIONAL INC., Piscataway, NJ (US)

(72) Inventors: Susan M. Mairs, St. Paul, MN (US); Bryan George Kinney, Stillwater, MN (US); Kimberly Hayman, Minneapolis, MN (US); Melissa Rose Schumann, Brooklyn Park, MN (US); Rachel Michael Nilsson, Minneapolis, MN (US); Jacob Larson, Minneapolis, MN (US)

(73) Assignee: TRANE INTERNATIONAL INC., Piscataway, NJ (US)

(21) Appl. No.: 13/972,417

(22) Filed: Aug. 21, 2013

Related U.S. Application Data
(60) Provisional application No. 61/691,543, filed on Aug. 21, 2012.

(51) Int. Cl. G06F 3/0482; G06F 3/0481

(52) U.S. Cl. CPC G06F 3/0482; G06F 3/04817
USPC 715/771

(57) ABSTRACT

A mobile device with a graphical user interface (GUI) for remotely monitoring and/or remotely interacting with a configurable building automation systems (BAS). In particular, the mobile device receives status data from the BAS, the GUI displays the status data on the mobile device, and the GUI allows a user to interact with the BAS.

### FIELD

This disclosure generally relates to a mobile device with a graphical user interface for remotely monitoring and/or operating a building automation system.

### BACKGROUND

A Building automation system (BAS) is used to coordinate, manage, and automate control of diverse environmental, physical, and electrical building subsystems, particularly HVAC and climate control, but also including security, lighting, power, and the like.

Hardwiring and programming of a BAS can create a robust fixed system customized for a particular installation. However, monitoring and maintenance of the BAS are still generally labor-intensive tasks that vary with each system implementation. In a common scenario, a user managing a building site must be at the location of the BAS and use a computer or other device hardwired to the BAS. If there is an issue with how the BAS is operating, the user managing the building site must physically be at the BAS to monitor the issue and to resolve the issue. If the user is not physically at the BAS location and receives notification that there is an issue with the BAS, generally, the user must physically go to the BAS location to monitor and to resolve the issue.

### SUMMARY

The embodiments described herein relate to a mobile device for interacting with a BAS remotely. Preferred embodiment relate to the mobile device for interacting with HVAC (heating, ventilation, and air conditioning) related aspects of the BAS.

The mobile device comprises a processor in communication with a network interface and a touchscreen. The network interface can receive data from the building automation system in real time, the network interface can send the data to the processor, and the processor can display the data in a portion of a graphical user interface (GUI). The processor can execute the instructions for the GUI and display the GUI on the touchscreen. The GUI includes a screen and a navigation bar, the navigation bar includes a plurality of icons, each of the icons is associated with an interactive screen, wherein a selection of one of the icons by touching the touchscreen is detectable by the processor to display in the screen the interactive screen associated with the one of the icons. The GUI is configured to receive user input data via the touchscreen, relay the user input data to the processor, the processor is configured to send the user input data to the building automation system via a transmission from the network interface.

In an embodiment, the mobile device includes a network interface that receives an alarm data from the building automation system in real time, the network interface sends the alarm data to the processor, and the processor displays receipt of the alarm data on the navigation bar of the GUI. Alarm data includes data that reports to the mobile device a particular condition of the BAS, a component of the BAS, a device connected to the BAS, a building (or a particular space or area of the building) connected to the BAS, and/or any combination thereof. That is, the data is about an area that is associated with the BAS, such as, but is not limited to, one or more of a component, a device, a unit, a system, a subsystem, a controller, a space, a building, a room, etc. The component may be the condenser or the evaporator, the unit may be a chiller, the system can be a HVAC system or circuit, the subsystem can be a control system for the HVAC system.

The alarm data can include undesirable conditions of an area of a building, such as the space being too warm or too cold. The alarm data can include variance of an area's temperature from a setpoint for the area's temperature that was previously set, for example, according to the BAS's operation schedule. The alarm data can include other types of data for sending a notification to the mobile device.

An embodiment of the mobile device includes a network interface that receives an alarm data from the building automation system in real time, the network interface sends the alarm data to the processor, and the processor displays receipt of the alarm data on the screen of the GUI.

An embodiment of the mobile device includes a network interface that receives an alarm data from the building automation system in real time, the network interface sends the alarm data to the processor, and the processor displays the alarm data on the screen.

Another embodiment of the mobile device includes the GUI configured to receive user input, wherein the user input data includes operational instructions for the BAS.

Another embodiment of the mobile device includes the GUI configured to receive user input, wherein the user input data includes commentary information that can be accessed and viewed by using another mobile device connected to the building automation system.

An embodiment of the mobile device includes a network interface that receives a plurality of alarm data from the building automation system in real time, the network interface sends the plurality of alarm data to the processor, and the processor displays the plurality of alarm data as a list of icons in the screen.

An embodiment of the mobile device includes a GUI that provides one or more of selectable options for organizing the list of icons in the screen, the GUI is configured to receive a selection of the selectable options by a touch on the touchscreen, and the processor displays in the screen an organized list of icons according to the selection. The GUI is configured so that each of the icons in the list of icons is selectable by a user by touching the touchscreen. The GUI is configured to receive a selection of one of the icons in the list of icons, change the interface screen to display a detailed information of the alarm data associated with the selection. The GUI provides an operational icon for removing the alarm data from being displayed in the list of icons.

### BRIEF DESCRIPTION OF THE DRAWINGS

Referring now to the drawings in which like reference numbers represent corresponding parts throughout.

FIG. 1 is a cartoon diagram of a building automation system (BAS) connected to a mobile device according to one embodiment.

FIG. 2 is a schematic diagram of a mobile device according to one embodiment.

FIG. 3 is a graphical user interface diagram for a mobile device according to an embodiment.

FIG. 4 is a graphical user interface diagram for a mobile device according to an embodiment.

FIG. 5 is a graphical user interface diagram for a mobile device according to an embodiment.

FIG. 6 is a portion of a graphical user interface diagram according to an embodiment.

FIG. 7 is a graphical user interface diagram for a mobile device according to an embodiment.

FIG. 8 is a graphical user interface diagram for a mobile device according to an embodiment.

FIG. 9 is a graphical user interface diagram for a mobile device according to an embodiment.

### DETAILED DESCRIPTION

The embodiments described herein are directed to a mobile device with a GUI for remotely monitoring and/or operating a building automation system.

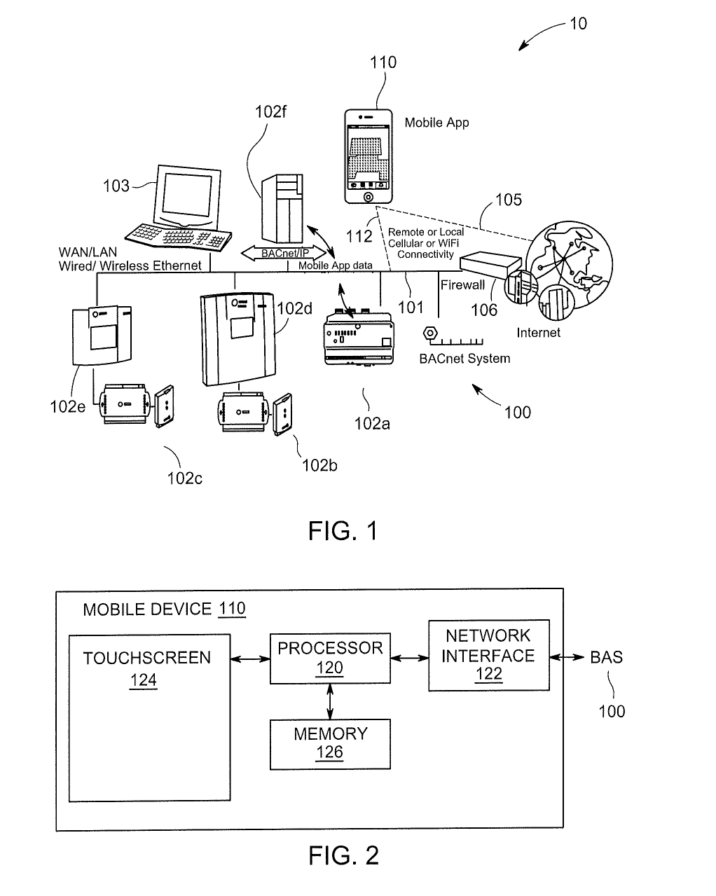

FIG. 1 shows a cartoon of a system 10 including an embodiment of a BAS 100 that includes a hardwired network 101 that uses a communication standard or protocol to link various subsystems, such as a system control unit 102a, a unit control device 102b, 102c, and/or other devices 102d, 102e, 102f, and provide a system-wide user access and control from a computer 103 hardwired to the network. The BAS 100 is connected to the internet 105, and includes a network security device 106, such as a firewall, that secures and protects the BAS 100 from unwanted intrusion via the internet 105.

The embodiment includes a mobile device 110 connectable to the BAS 100 via the internet 105, accessing the BAS 100 through the network security device 106. The mobile device 110 can connect to the BAS 100 via a local wireless connection 112. The local wireless connection 112 can be established behind the network security device 106, so that the mobile device 110 can connect to one or more of the components or devices 102a-f of the BAS 100 without requiring the communication between the mobile device 110 and the BAS 100 to go through the network security device 106.

The mobile device 110 can connect to the BAS 100 via the internet 105 using cellular, 3G, 4G, or other wireless communication protocol. The mobile device 110 can connect to the BAS 100 via the local wireless connection 112 using WiFi, bluetooth, or other wireless communication protocol. The mobile device 110 can connect to the BAS 100 using a combination of the internet 105 and local wireless connection 112.

FIG. 2 shows an illustrated schematic diagram of an embodiment of a mobile device 110. The mobile device 110 includes a processor 120 in communication with a network interface 122 and a touchscreen 124. The touchscreen 124 is a combination display and a human-computer interface device. The touchscreen 124 displays images as instructed by the processor 120. The touchscreen 124 can detect user input via touch or contact by a human finger or a stylus device, and sends the input to the processor 120. A memory 126 is in communication with the processor 120, and the memory 126 stores instructions for an operating system that is executed by the processor 120. The memory 126 can also store instructions for a computer program that is executed by the processor 120. The computer program includes a GUI for remote operation of a BAS 100.

Embodiments of the mobile device 110 include, but are not limited to, a smartphone, an iPhone, an iPad, an iPod, an Android phone, an Android tablet, a Windows phone, a Windows tablet, etc. Embodiments of the operating system include, but are not limited to, iOS, Android OS (e.g. Donut, Eclair, Gingerbread, Honeycomb, Ice Cream Sandwich, Jelly Bean, etc.), Windows, etc. Embodiments of the computer program include, but are not limited to, software for mobile device 110s commonly called an “App” or “Mobile App,” a script written in a scripting language, etc.

According to an embodiment, a GUI is displayed on the touchscreen 124 when the computer program instructions are executed by the processor 120, the GUI displays information to a user and also provides various input points for the user to interact with the GUI so that the user is allowed to provide input, such as operational commands or data request, which is sent to the processor 120. The processor 120 can then process the input according to the computer program instructions being executed and can communicate with the memory 126 and/or network interface 122 to provide data to be displayed on the touchscreen 124.

An embodiment of a computer program is stored on a computer readable medium, wherein the computer program includes computer readable instructions that can be executed by a processor 120 to display a GUI on a touchscreen 124 configured to provide data output on the touchscreen 124, and at the same time, receive operational input for remotely monitoring and/or operating a BAS 100. The data output provided can be in real time, as the data is received from the BAS 100 to the mobile device 110 via the network interface 122 of the mobile device 110.

Accordingly, a user of the mobile device 110 can be located almost anywhere and monitor and/or interact with the operation of the BAS 100, as long as the mobile device 110 can wirelessly connect to the BAS 100.

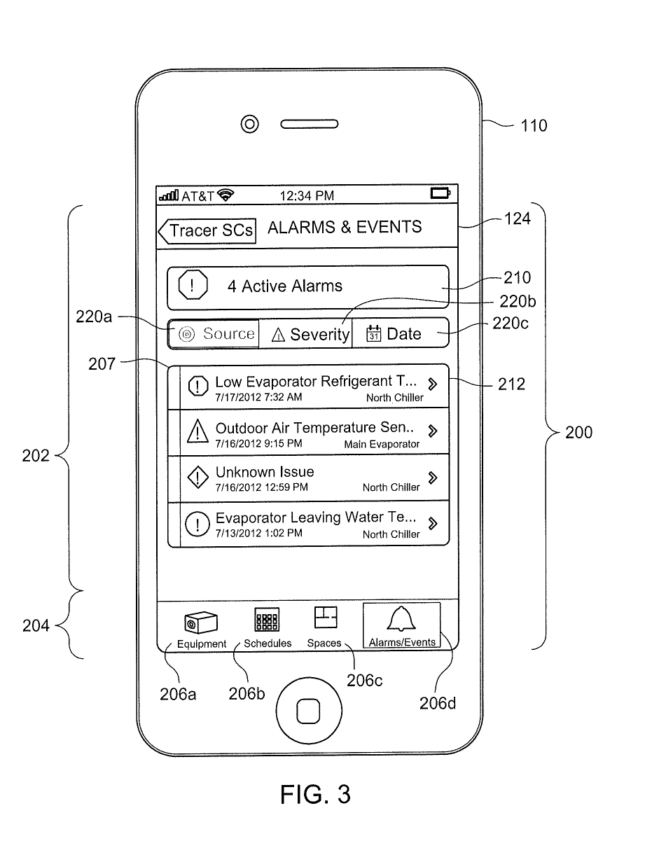

FIG. 3 shows an illustration of an embodiment of a mobile device 110 for remote operation of a building automation system. The mobile device 110 has a touchscreen 124 displaying a GUI 200 which includes a screen portion 202 (or screen) and a navigation bar portion (or navigation bar) 204. The navigation bar 204 includes a plurality of icons 206a, 206b, 206c, 206d, each of the icons 206a-d being associated with an interactive screen, so that when one of the icons is selected by touching the touchscreen 124, the interactive screen associated with the selected icon (for example, FIG. 3 shows the interactive screen 207 that is associated with the icon 206d) is displayed in the screen 202 of the GUI 200. The GUI 200 is configured to receive user input data via the touchscreen 124, relay the user input data to the processor. The processor is configured to send the received user input data to the BAS via a transmission from the network interface.

The screen 202 of the GUI 200 can show receipt of alarm data 210 from a BAS. When the network interface receives an alarm data from the BAS, the network interface sends the alarm data to the processor, and the receipt of alarm data 210 can be displayed in the GUI 200, such as in the screen 202.

Further, the GUI 200 can show a plurality of alarm data as a list of icons 212 in the screen 202 of the GUI 200. When the network interface receives a plurality of alarm data from the BAS, the network interface sends the plurality of alarm data to the processor, and the processor displays the plurality of alarm data as a list of icons 212 in the screen 202 in real time. That is, as alarm data is received by the mobile device 110, the newly received alarm data is added to the list of icons 212. Similarly, when the mobile device 110 receives alarm data from the BAS to cancel an alarm, that alarm data is deleted (or removed) from the list of icons 212.

The GUI 200 provides one or more of selectable options 220a, 220b, 220c, for organizing the list of icons 212 in the screen 202. The GUI 200 is configured to receive a selection of the selectable options 220a-c when the touchscreen 124 is touched, and the processor processes that selection to reorganize the list of icons 212 according to the selection (i.e. a user's desired order of listing the alarm icons).

Accordingly, the mobile device 110 can operate in the following manner. When the BAS sends an alarm to the mobile device 110, a user of the mobile device 110 is alerted by the mobile device 110 that there is an alarm by the receipt of the alarm data being displayed in the GUI 200 of the mobile device 110. The user can interact with the GUI 200 to view the alarm data, organize the alarm data if there are more than one, view a detailed information regarding the alarm data using the mobile device 110, monitor and/or check the status of the BAS, any of the devices connected to the BAS, and/or an area that the BAS controls.

Further, the user can be notified by a phone call, email, etc. that there is a problem (e.g. a space is too hot or cold) with a building and/or BAS. Then, the user can use the mobile device 110 to connect to the BAS that controls the space, and monitor an alarm data received from the BAS using the mobile device 110 without having to physically go to the location of the BAS (or to the area where the alarm data is associated with).

The mobile device 110 with the GUI 200 can monitor in real time various data, such as, but not limited to, condition data of an area associated with the BAS. The condition data includes, but are not limited to, space temperature, space temperature setpoint, variance of space temp from setpoint, discharge air temperature, supply water or air temperature, space humidity, space power status, space light status, space airflow, and/or alarms for the space. Further, condition data includes equipment data, such as the operating information and setpoints for air handlers such as, but not limited to, duct static pressure, heating and cooling capacity, discharge air temperature and flow, and supply fan control, and for chillers such as, but not limited to, running mode, running capacity, evaporator leaving water temperature, chilled water setpoint, demand limit setpoints and active heating or cooling setpoints. Further, condition data includes system data, such as the operating information and setpoints for area systems such as, but not limited to, the same type of data as for spaces, economizing and humidity management, outdoor air conditions, optimal start conditions, night purge functions, and data about its space and equipment member participants; for chiller plant systems such as, but not limited to, chilled water data for sensors, request, return, pump, supply and cooling rate, chiller rotation schedule and priorities, and chiller operation shutdowns, lockouts, and delays, and data about its chiller equipment member participants; and for variable air systems such as, but not limited to, space temperature minimum and maximum settings, duct static optimization, ventilation optimization, calibration management, common space commands, and data about its space and air handler member participants. Further, condition data includes point data for user created points in the system such as their current value, their service state and values, the minimum and maximum values, and their alarm trigger conditions. Further, condition data includes override data for any of the above-mentioned controllable data including whether the setpoints can be overridden, are currently being overridden and at what priority level, and whether the override is permanent or will expire and at what time. Further, condition data includes schedule data including, but not limited to the schedule that is active to run at any time of any day, the normal schedule for any time and the exception schedules being applied for that time, and the transition values each time the schedule is expected to change, whether a schedule has optimization settings for start and stop times, and all the member equipment that is participating in the active schedule.

Further, the mobile device 110 can interact with a BAS by using the GUI 200, so that the GUI 200 can provide displays of, for example, historical data of the space, i.e. past alarms, real time data, scheduled operation information of the space, etc.

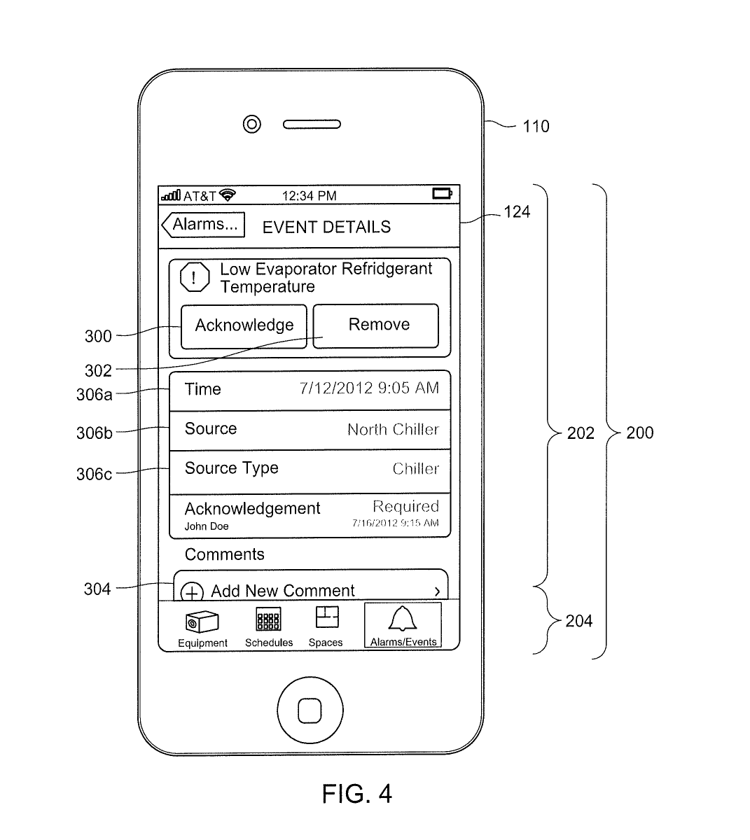

FIG. 4 shows an embodiment of the mobile device 110 with a GUI 200 having a screen 202 and a navigation bar 204 displayed on the touchscreen 124 of the mobile device 110. FIG. 4 illustrates the screen 202 showing an interactive screen having a detailed view of information associated with and/or included in a received alarm data. The screen 202 of the GUI 200 can include one or more interactive icons (or buttons) for interacting with the received alarm data and/or the BAS. FIG. 4 shows two interactive icons 300, 302 for interacting with the received alarm data and/or the BAS. However, it is to be understood that more than two interactive icons can be displayed in the screen of the GUI for interacting with the received alarm data and/or the BAS.

The interactive icons 300, 302 displayed in the screen 202 of the GUI 200 are selectable by a user by touching the touchscreen 124. The interactive icons 300, 302 can remove the alarm data from being displayed in the list of icons in the screen 202 (e.g. see FIG. 3 for the list of icons 212).

Further, one of the interactive icons shown in FIG. 4 is an acknowledge icon 300 that removes the alarm data from being displayed in the list of icons in the screen 202, and also instructs the processor to send feedback data to the BAS (or a device that is a part of the BAS), wherein the feedback data indicates that a user of the mobile device 110 has viewed the alarm data information. Accordingly, the acknowledge icon 300 of the GUI 200 provides the user with an ability to confirm the receipt and viewing of the alarm data back to the BAS with a “single click (or touch)” of the touchscreen 124 of the mobile device 110.

The Comments section displayed in the screen allows the user to view information (e.g. user input data, such as commentary information) stored at the BAS side. Said information can include user input data, such as commentary information and/or operational instructions for the BAS.

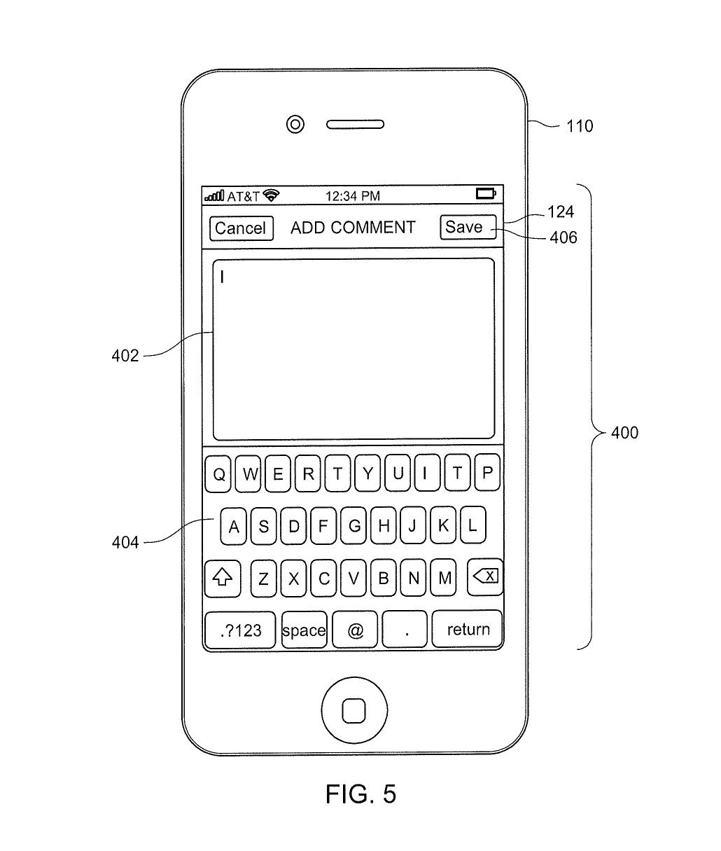

Further, the GUI 200 can include another interactive icon 304 providing a user with an ability to interact with the BAS in the following manner. The Add New Comment icon 304 can be used to provide new information for sending to the BAS, to be stored at the BAS, so that others can view the new information. For example, when the Add New Comments icon 304 is selected by a user touching the touchscreen 124, the GUI 400 shown in FIG. 5 can be shown on the touchscreen 124 of the mobile device 110.

Further, the GUI 200 displays additional information of the alarm data, such as, “Time” of the alarm 306a, the “Source” of the alarm 306b, “Source Type” of the alarm 306c, etc. The “Source” 306b can be interactive, such as, when a user touches the “Source” 306b in the GUI 200, the GUI 200 changes the screen 202 to display, for example, a screen showing detailed information about the “Source,” similar to the screen 602 shown in FIG. 7.

FIG. 5 illustrates an embodiment of a mobile device 110 providing for a user to add new information using an embodiment of the GUI 400. The GUI 400 includes a text field 402 for displaying entered information and a keyboard field 404 for providing a human-computer keyboard interface. A user can select the Save icon 406 by touching it on the touchscreen 124 to send the information displayed on the text field 402 to the BAS. The information is stored at the BAS side so that others can access and view the information. For example, the information can be accessed and viewed by using another mobile device connected to the BAS.

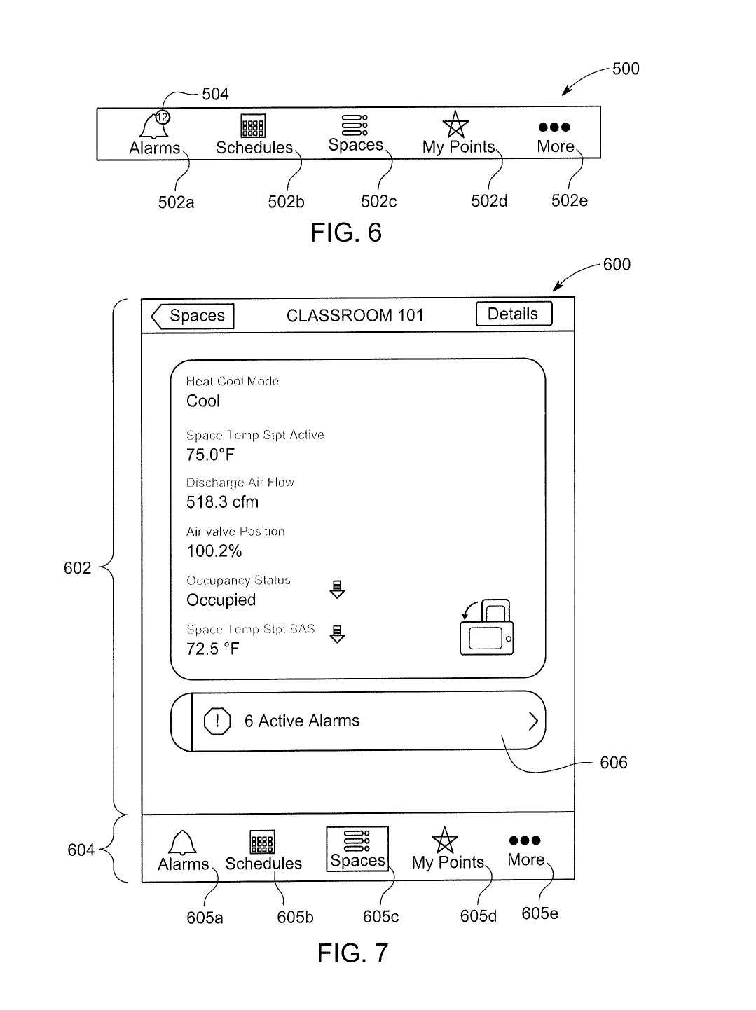

FIG. 6 shows an embodiment of a navigation bar 500 having a plurality of icons 502a, 502b, 502c, 502d, 502e, which is a portion of a GUI for a mobile device. When a network interface of the mobile device receives an alarm data from a BAS, the network interface sends the alarm data to a processor of the mobile device, and the processor displays receipt of the alarm data on the navigation bar 500 of the GUI in real time. For example, a numerical counter 504 is displayed next to one of the icons 502a in the navigation bar 500, indicating how many alarm data has been received. The numerical counter 504 can change based on the number of alarm data received (and/or removed) as the alarm data is received by the mobile device.

FIG. 7 shows another embodiment of the GUI 600 displayed on a touchscreen of a mobile device. The GUI 600 is in portrait mode, showing a screen 602 of the GUI 600 positioned above a navigation bar 604 having a plurality of icons 605a, 605b, 605c, 605d, 605e. The screen 602 shows real time conditions of an area (i.e. space) of a building that is controlled by the BAS. The real time conditions are from real time data sent from the BAS, received by the network interface of the mobile device, processed by the processor of the mobile device, and displayed on the touchscreen of the mobile device within the GUI 600. The receipt of alarm data 606 is displayed in the screen 602.

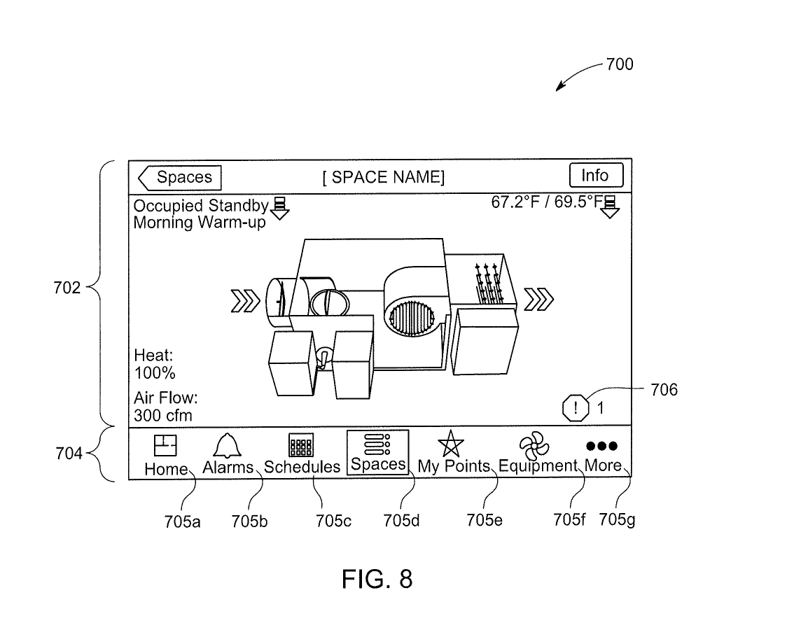

FIG. 8 shows another embodiment of the GUI 700 displayed on a touchscreen of a mobile device. The GUI 700 is in landscape mode, showing a screen 702 of the GUI 700 positioned above a navigation bar 704 having a plurality of icons 705a, 705b, 705c, 705d, 705e, 705f, 705g. The screen 702 shows real time condition information of an area (i.e. space) of a building that is controlled by the BAS. The screen 702 can include a graphic (static and/or animated) of the area associated with the condition data being displayed. The real time condition information are from real time data sent from the BAS, received by the network interface of the mobile device, processed by the processor of the mobile device, and displayed on the touchscreen of the mobile device within the GUI 700. The receipt of alarm data 706 is displayed in the screen 702.

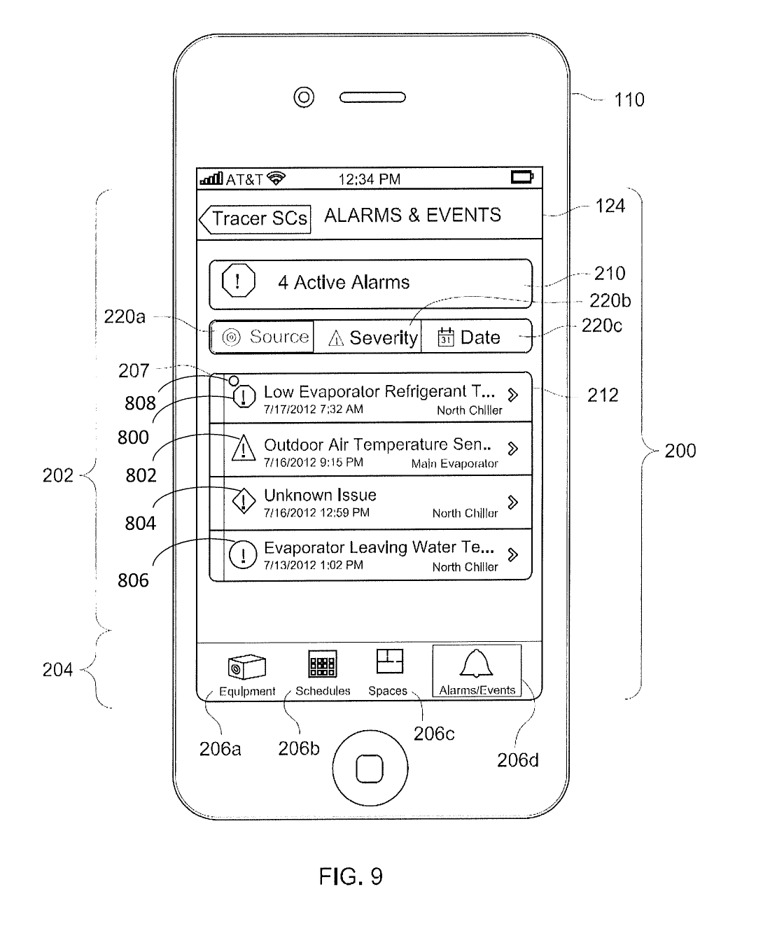

FIG. 9 shows a graphical user interface diagram for the mobile device 110 similar to that shown in FIG. 3, with similar features being identified with the same reference numbers. FIG. 9 shows each of the alarms displayed in the list of icons 212 having an indicator 800, 802, 804, 806 which represent a severity level of the alarm, For example, the shape and/or color of the indicators 800, 802, 804, 806 can represent the severity level of the alarm. Further, an additional indicator 808 may be displayed associated with each of the alarms displayed in the list of icons 212 for providing additional information, such as, that an acknowledgement is required for that alarm. The acknowledgement may be made, for example, by interacting with the user interface shown in FIG. 4 (e.g., interacting with the acknowledge icon 300 of the GUI 200 shown in FIG. 4).

With regard to the foregoing description, it is to be understood that changes may be made in detail, especially in matters of the construction materials employed and the shape, size and arrangement of the parts without departing from the scope of the present invention. It is intended that the specification and depicted embodiment to be considered exemplary only, with a true scope and spirit of the invention being indicated by the broad meaning of the claims.

What is claimed is:

1. A mobile device for remote operation of a building automation system, comprising:
a processor in communication with a network interface and a touchscreen;
the network interface can receive data from the building automation system in real time, the network interface can send the data to the processor, and the processor can display the data in a portion of the graphical user interface;
the processor executing instructions for a graphical user interface and displaying the graphical user interface on the touchscreen; and
the graphical user interface includes a screen and a navigation bar, the navigation bar includes a plurality of icons, each of the icons is associated with an interactive screen, wherein a selection of one of the icons by touching the touchscreen is detectable by the processor to display in the screen the interactive screen associated with the one of the icons,
the graphical user interface is configured to receive user input data via the touchscreen, relay the user input data to the processor, the processor is configured to send the user input data to the building automation system via a transmission from the network interface.

2. The mobile device according to claim 1, wherein the network interface receives an alarm data from the building automation system in real time, the network interface sends the alarm data to the processor, and the processor displays receipt of the alarm data on the navigation bar of the graphical user interface.

3. The mobile device according to claim 1, wherein the network interface receives an alarm data from the building automation system in real time, the network interface sends the alarm data to the processor, and the processor displays receipt of the alarm data on the screen of the graphical user interface.

4. The mobile device according to claim 1, wherein the network interface receives an alarm data from the building automation system in real time, the network interface sends the alarm data to the processor, and the processor displays the alarm data on the screen.

5. The mobile device according to claim 1, wherein the user input data includes operational instructions for the building automation system.

6. The mobile device according to claim 1, wherein the user input data includes commentary information that can be accessed and viewed by using another mobile device connected to the building automation system.

7. The mobile device according to claim 1, wherein the network interface receives a plurality of alarm data from the building automation system in real time, the network interface sends the plurality of alarm data to the processor, and the processor displays the plurality of alarm data as a list of icons in the screen.

8. The mobile device according to claim 7, wherein the graphical user interface provides one or more of selectable options for organizing the list of icons in the screen, the graphical user interface is configured to receive a selection of the selectable options by a touch on the touchscreen, and the processor displays in the screen an organized list of icons according to the selection.

9. The mobile device according to claim 7, wherein each of the icons in the list of icons is selectable, the graphical user interface is configured to receive a selection of one of the icons in the list of icons, change the interface screen to display a detailed information of the alarm data associated with the selection.

10. The mobile device according to claim 7, wherein the graphical user interface provides an operational icon for removing the alarm data from being displayed in the list of icons.
